(19) United States
(12) Patent Application Publication
(10) Pub. No.: US 2007/0062905 A1
(43) Pub. Date: Mar. 22, 2007

(54) Leak-proof bottle cap

(76) Inventor: Ming-Hua Hung, Tucheng city (TW)

Correspondence Address: BACON & THOMAS, PLLC, 625 SLATERS LANE, FOURTH FLOOR, ALEXANDRIA, VA, 22314, US

(21) Appl. No.: 11/224,231

(22) Filed: Sep. 13, 2005

(51) Int. Cl. B65D 51/16; B67D 3/00; A47G 19/22

(52) U.S. Cl. 215/311; 215/387; 222/525; 222/559; 220/254.9; 220/714; 220/717

(57) ABSTRACT

A leak-proof bottle cap comprises a main body and a flanged cap. The main body has a flanged column vertically connected to a circular base, comprising an upper neck with an upper flange, an lower neck with a lower flange, a fixed plug at a tip, and multiple through holes surrounding the plug. The flanged cap is releasably attached onto the flanged column allowing a mouth end of the flanged cap to be lodged in a circle ditch. The outer rim of the upper flange is in close contact with the inner rim of the flanged cap, and the lower flange acts to block the upward movement of a catch ring on an inner wall of the flanged cap when the flanged cap is pulled up, so the mouth of the flanged cap is always covered by the circle ditch. This structural design can ensure tight sealing of the bottle to prevent spilling in any conditions.

### BACKGROUND OF THE INVENTION

1. Field of the Invention

The present invention relates to a bottle cap that can tightly seal a bottle to prevent any spilling in any conditions.

2. The Prior Arts

The conventional bottle caps of sport bottles or sipper bottles allow users to pull a plug that covers a center hole of the caps to sip or pour water through the center hole, which means the cap is not physically detached from the bottle when opened. There is a valve mechanism embedded in the bottle cap to control the water flow from the bottle.

Referring to FIGS. 4 and 5, the conventional valve-controlled water bottle comprises a main body A and a ball-shaped cap B. A flanged column A2 is connected to a circular base of the main body A, and has an external flange A21 on an outer wall and multiple ribs supporting a fixed plug A1 in a center thereof. The ball-shaped cap B has two concentric tubes B1, B2 on an underside, where the outer rim of the inner tube B2 has an almost equal diameter with the inner rim of the flanged column A2, and the inner rim of the outer tube B1 has a slightly larger diameter than the outer rim of the flanged column A2. The outer tube B1 has an internal flange B11 around a mouth end thereof. The cap B has an outlet port B3 at a tip to allow water to flow or pour out when the plug A1 is released.

To have the cap successfully assembled, the open mouth of the flanged column A2 is inserted between the concentric inner tube B2 and outer tube B1, that means the tube B2 on the ball cap B is slipped inside the flanged column A2, and the outer tube B1 is outside the flanged column A2.

When the cap B is pushed in, the plug A1 is inserted into the outlet port B3 shutting the outlet port B3 to prevent water from spilling (see FIG. 4). When the cap B is pulled up (see FIG. 5), the plug A1 is released from the outlet port B3, so that the water can be poured through the outlet port B3.

The main disadvantage of the conventional bottle cap is that the rubber cap will experience material fatigue after prolonged use. The abrasion of the surface layer between the inner tube B2 and the flanged column A2 causes a gap to develop, which leads to water spilling from the bottle.

The structure of the bottle cap has another major flaw. Since the cylindrical walls of the inner tube B2, outer tube B1 and the flanged column A2 are normally overlapped, but after the cap B is pulled up (see FIG. 5), the coverage area is reduced to a narrow range, causing the easy spilling of water from the bottle.

The mouth of the cap B is usually exposed according to the conventional design. There is a real chance that the internal flange of the cap B will slip pass the blocking external flange of the flanged column A2 when the cap B is pulled forcefully, which may cause the cap B to be disengaged from the flanged column A2. In such a case, the cap B may fall to the ground and introduce contamination to the water inside the bottle. Nevertheless, the gap will continue to grow, and the leaking problem will get worse unless the cap is replaced.

In these aspects, a leak-proof bottle cap according to the present invention substantially reduces or obviates the limitations and disadvantages of the prior art.

### SUMMARY OF THE INVENTION

The primary object of the present invention is to provide a leak-proof bottle cap with highly resilient and durable structure that can ensure tight coupling between a flanged column and a flanged cap.

The second object of the present invention is to provide a leak-proof bottle cap that has a mouth end of the flanged cap confined within the space of a circle ditch surrounding a bottom of the flanged column, which is designed to prevent the disengagement of the flanged cap and the flanged column if the flanged cap is pulled forcibly.

To attain the above-mentioned objects, a leak-proof bottle cap in accordance with the present invention comprises a main body and a flanged cap, where the main body has a flanged column vertically erected from a center of a circular base, comprising an upper neck with an upper flange and a lower neck with a lower flange, and a fixed plug at a tip, and multiple through holes on the upper neck of the flanged column and surrounding the plug. The flanged cap is formed with an open mouth on one end and an outlet port on the other end, and a flange on an inner wall near the mouth.

In accordance with a first aspect of the present invention, the internal flange is formed on the inner rim of the flanged cap near the bottom end, which is actually a catch ring with a hook at an end thereof. The catch ring is designed to block the movement of the mouth of the flanged cap in the reverse direction. The inner rim of the catch ring (flange) has a slightly smaller diameter than the outer rim of the lower flange on the lower neck, and the inner rim of the flanged cap near the outlet port has a slightly smaller diameter than the outer rim of the upper flange on the upper neck of the flanged column. When the flanged cap is coupled onto the flanged column, the outer rim of the upper flange is in close contact with the inner rim of the flanged cap, and the lower flange on the lower neck is to block the upward movement of the catch ring attached to the flanged cap.

In accordance with a second aspect of the present invention, a circle ditch is formed around a bottom end of the flanged column, in between the outer rim of the lower neck and the inner rim of the circular base. The catch ring on the mouth end of the flanged cap slips pass the lower flange on the lower neck and lodges in the circle ditch when assembled. When the flanged cap is pulled up, the lower flange on the lower neck of the flanged column acts to block the upward movement of the catch ring on the inner wall of the flanged cap, so that the mouth of the flanged cap shall be able to move within a prescribed range in the space of the circle ditch. If not, the flanged cap could be disengaged from the main body if the cap is pulled forcibly.

The new cap structure does not require any additional parts other than those already being used, but the structural design of the flanged cap and the flanged column is considerably modified in the present invention in order to make a tight coupling of the flanged cap and the flanged column.

These along with other features of novelty, which characterize the present invention, are pointed out with particularity in the claims annexed to and forming a part of this disclosure. For a better understanding of the present invention, the operating advantages and the specific objectives attained by its uses, references should be made to the accompanying drawings and descriptive matter illustrated in preferred embodiments of the present invention.

### BRIEF DESCRIPTION OF THE DRAWINGS

FIG. 1 is a sectional view of a flanged cap and a flanged column in accordance with the present invention;

FIG. 2 is a sectional view showing an assembly of the flanged cap and the flanged column when the cap is pushed in;

FIG. 3 is a sectional view showing an assembly of the flanged cap and the flanged column when the cap is pulled up;

FIG. 4 is a sectional view of a conventional bottle cap when the cap is pushed in; and

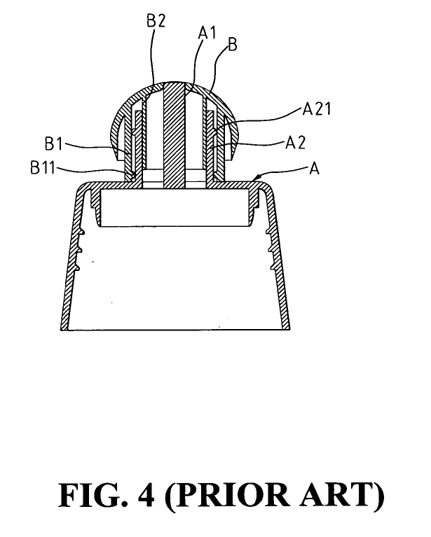

FIG. 5 is a sectional view of the conventional bottle cap when the cap is pulled up.

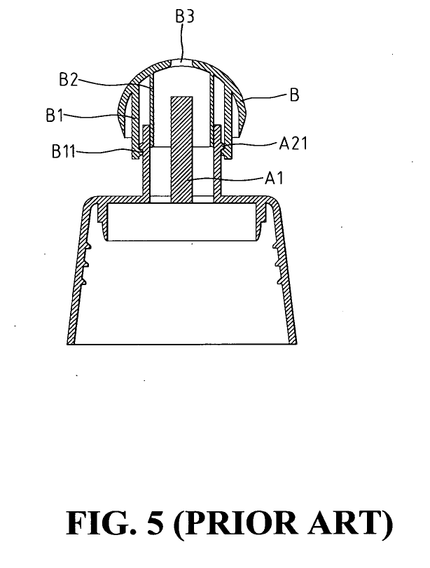

### DETAILED DESCRIPTION OF THE PREFERRED EMBODIMENT

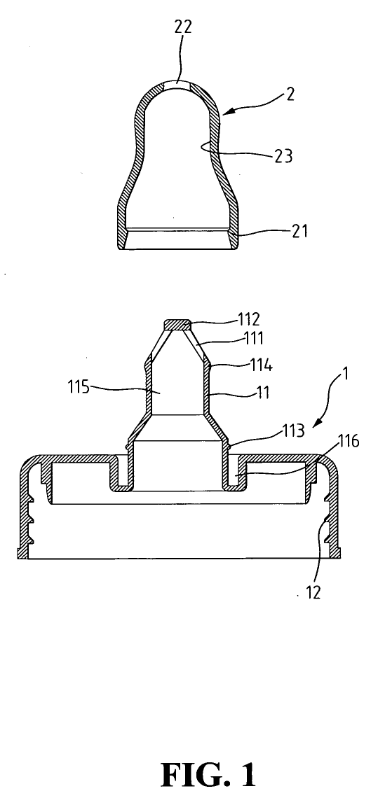

Referring to FIG. 1, a leak-proof bottle cap in accordance with the present invention comprises a main body 1 and a flanged cap 2. The main body 1 has threads 12 on an inner wall to fit on a mouth of a bottle having outer threads (not shown).

The main body 1 has a circular base and a flanged column 11 that erects from a center of the circular base and comprises an upper neck with an upper flange 114 on an outside wall and a lower neck with a lower flange 113 on the outside wall, where the outer rim of the upper flange 114 has a smaller diameter than the outer rim of the lower flange 113, forming a step-like column structure.

A plug 112 is formed at a tip of the flanged column 11, being surrounded by multiple through holes 111 on the upper neck. A circle ditch 116 is formed around a bottom end of the flanged column 11, in between the outer rim of the lower neck and the inner rim of the circular base.

The flanged cap 2 has an open mouth on one end and an outlet port 22 on the other end. The flanged cap 2 has a catch ring 21 on an inner wall 23 near the mouth end. The flanged cap 2 is constructed in such a way that the inner rim of an upper neck of the cap 2 has a slightly smaller diameter than the outer rim of the upper flange 114, and that the inner rim of the catch ring 21 has a smaller diameter than the outer rim of the lower flange 113.

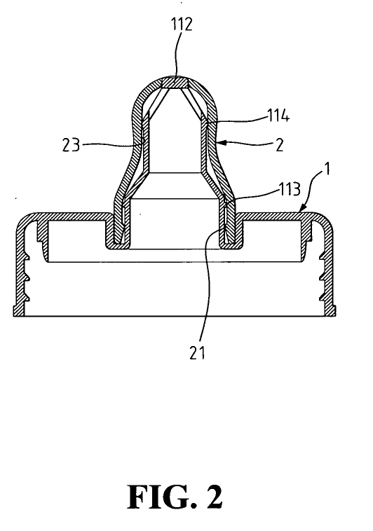

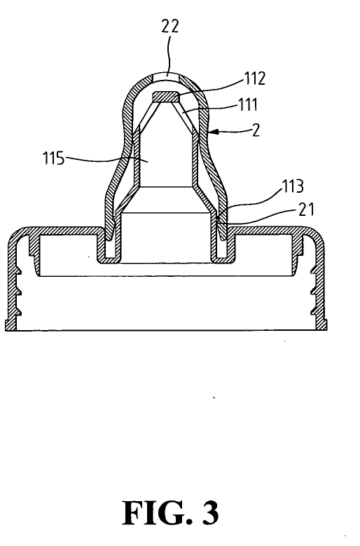

When the flanged cap 2 is pushed in (see FIG. 2), the plug 112 is automatically inserted into the outlet port 22, so that the outlet port 22 is shut to prevent spilling. When the flanged cap 2 is pulled up (see FIG. 3), the plug 112 is released from the outlet port 22, so that water can flow out by way of a central conduit 115, the through holes 111 and the outlet port 22 for sipping or drinking by the user.

When the flanged cap 2 is attached onto the flanged column 11 of the main body 1, the catch ring 21 on the inner wall 23 of the flanged cap 2 slips pass the lower flange 113 and lodges in the circle ditch 116. Since the inner rim of the upper neck of the flanged cap 2 has a slightly smaller diameter than the outer rim of the upper flange 114, the inner rim of the flanged cap 2 is always in close contact with the outer rim of the upper flange 114.

In the preferred embodiment of the present invention, the circle ditch 116 is formed around the bottom end of the flanged column 11, so after the catch ring 21 on the inner rim of the flanged cap 2 slipped pass the lower flange 113 on the lower neck, the mouth of the flanged cap 2 is lodged in the circle ditch 116.

When the flanged cap 2 is pulled up, the lower flange 113 acts to block the upward movement of the catch ring 21 on the inner wall 23 of the flanged cap 2, so that the mouth end of the flanged cap 2 will always be covered in the space of the circle ditch 116 even when the flanged cap 2 is pulled forcibly.

This safety feature can effectively prevent the decoupling of the flanged cap 2 and the flanged column 11. If not, the catch ring 21 of the flanged cap 2 could slip pass the blocking of the lower flange 113 and cause the flanged cap 2 to be disengaged from the flanged column 11 when the flanged cap 2 is pulled forcibly.

Although the present invention has been described with reference to the preferred embodiments thereof, it is apparent to those skilled in the art that a variety of modifications and changes may be made with regard to different forms and shapes without departing from the spirit and scope of the present invention which is intended to be defined by the appended claims.

What is claimed is:

1. A leak-proof bottle cap, comprising:
a main body having a circular base and a flanged column, where the flanged column erects from a center of the circular base and comprises an upper neck with an upper flange on an outer wall, a lower neck with a lower flange on the outside wall, a fixed plug at a tip and multiple through holes surrounding the plug; and
a flanged cap releasably attached onto the flanged column and having an open mouth on one end and an outlet port on the other end, and a catch ring on an inner wall near the mouth end, where the inner rim of the catch ring has a slightly smaller diameter than the outer rim of the lower flange, and the inner rim of an upper neck of the flanged cap has a slightly smaller diameter than the outer rim of the upper flange.

2. The bottle cap as claimed in claim 1, wherein a circle ditch is formed around a bottom end of the flanged column, in between the outer rim of the flanged column and the inner rim of the circular base, for receiving the mouth end of the flanged cap when the cap is assembled.

3. The bottle cap as claimed in claim 1, wherein the flanged column is constructed in such a way that the outer rim of an upper neck of the flanged column has a smaller diameter than the outer rim of the lower flange, forming a step-like column structure.

4. The bottle cap as claimed in claim 2, wherein the flanged column is constructed in such a way that the outer rim of an upper neck of the flanged column has a smaller diameter than the outer rim of the lower flange and forms a step-like column structure.

5. The bottle cap as claimed in claim 2, wherein the catch ring on the inner wall of the flanged cap and the lower flange on the outer wall of the flanged column jointly act to block the upward movement of the flanged cap when the flanged cap is pulled forcibly, so that the mouth of the flanged cap shall always be held in the space of the circle ditch.
